(19) United States
(12) Patent Application Publication
(10) Pub. No.: US 2006/0101958 A1
(43) Pub. Date: May 18, 2006

(54) Table saw

(76) Inventors: Jaime E. Garcia, Jackson, TN (US); Jeffrey D. Weston, Jackson, TN (US)

Correspondence Address: THE BLACK & DECKER CORPORATION, 701 EAST JOPPA ROAD, TW199, TOWSON, MD, 21286, US

(21) Appl. No.: 10/897,575

(22) Filed: Jul. 23, 2004

Related U.S. Application Data
(60) Provisional application No. 60/491,790, filed on Jul. 31, 2003.

(51) Int. Cl. B23D 19/00

(52) U.S. Cl. 83/13; 83/469

(57) ABSTRACT

A table saw includes a worktable mounted on a first and second workstation. The worktable includes two blade access assemblies for operationally enabling saw blades to extend through the worktable and operate upon a work piece. Each workstation includes a housing disposed with a saw assembly comprising a motor coupled with a saw blade which extends through the blade access assemblies. The table saw allows for the performance of two separate cutting operations upon a work piece, which is engaged with the worktable, by the saw blades.

### CROSS REFERENCE TO RELATED APPLICATION

The present application claims priority under 35 U.S.C. § 119(e) to the U.S. Provisional Application Ser. No. 60/491,790, filed on Jul. 31, 2003, which is herein incorporated by reference in its entirety.

### FIELD OF THE INVENTION

The present invention generally relates to the field of woodworking tools, and particularly to a table saw enabled with dual saw blade functionality.

### BACKGROUND OF THE INVENTION

Wood working operations are performed using a variety of tools which come in a variety of sizes. Typically, woodworkers select their tools based on any number of factors, which may include available shop space, efficiency of tool operation, costs, and functionality provided. Often woodworkers are faced with having to use multiple tools to accomplish a single task or engage in time consuming, preparatory steps in order to achieve their goals. For example, much time may be consumed in changing the working tool mounted in the workstation, such as a saw, because the woodworker must physically remove a power tool from a workstation in order to conduct a second operation. This process may be quite disruptive, consuming time and decreasing production capabilities which may lead to user dissatisfaction.

Unfortunately, for operations that require the use of multiple power tools, there has not been provided an easy to use, affordable tool that provides such multiple functionality. While capabilities exist, for instance to switch out saw blades in a power saw, this still consumes time away from performing the operation at hand. Also, available space has become a factor in decreasing the usefulness of tools when a user has to sacrifice the efficient use of one tool in order to have a second tool available.

Therefore, it would be desirable to provide a power tool with multiple functionalities that utilized a limited amount of space.

### SUMMARY OF THE INVENTION

Accordingly, the present invention is directed to a table saw which provides an operator the ability to operate two saws utilizing substantially the same floor space as would be occupied by a commonly available table saw. This is of particular advantage to power tool operators who have limited space within which to operate the power tools. The apparatus of the present invention is also advantageous to a power tool operator who may need to perform a variety of operations upon a work piece. For instance, a typical table saw may require a change of blades to perform two different cuts. The table saw of the present invention may present both blades to an operator saving them significant time and effort, thereby increasing productivity and decreasing fatigue.

In a first aspect of the present invention, a table saw comprises a first workstation disposed with a first power tool and a second workstation disposed with a second power tool. A worktable couples with the first and second workstations. The worktable includes a first power tool access assembly disposed in relation to the first power tool and a second power tool access assembly disposed in relation to the second power tool. The worktable provides for dual operation of the first and second power tool.

For example, the first and second power tools may both be saw assemblies. The first saw assembly may be operably engaged by a combination bevel and height adjustment assembly while the second saw assembly may be operably engaged by only a height adjustment assembly. The enabling of only one blade with beveling capabilities may reduce the costs to the consumer for the table saw of the present invention. Further, typical consumers of power saws, such as table saws, often desire the ability to perform bevel cuts and are willing to absorb the increased labor costs of re-positioning a single blade table saw system for such functionality. Further, consumers are often unwilling to bear the increased expense of buying a second table saw system in order to perform their straight cuts. The present invention provides a user a single system which provides both bevel cutting and straight cutting, increasing the efficiency with which they may perform their tasks. Additionally, the present invention may reduce the costs of having dual systems available.

Another advantage of the present invention is that the user may perform dual cutting functions at the same time upon a work piece, perform the cuts in sequence, or even make use of only one of the saws. For example, a woodworker may use both blades at once to pre-cut specified work pieces. Alternately, a woodworker may lower the second saw assembly, using the height adjustment assembly, below the plane of the worktable and perform a cut using only the first saw assembly. In such a configuration a user of the table saw may perform all types of cuts using the first saw assembly, such as beveled cuts, while maintaining a second straight cut capability just below the surface which may be easily accessed by a user through the height adjustment assembly.

In a second aspect of the present invention, a table saw assembly is provided comprising a worktable including a first blade access assembly and a second blade access assembly. A first workstation is coupled with the worktable, the first workstation comprising a saw assembly including a motor coupled with a first saw blade. The first saw blade operationally engages through the first blade access assembly of the worktable. A second workstation is also coupled with the worktable, the second workstation comprising a saw assembly including a motor coupled with a second saw blade, the second saw blade operationally engaging through the second blade access assembly of the worktable. The worktable provides for dual operation of the first saw blade and the second saw blade.

In an additional aspect of the present invention, a method for performing woodworking operations is given. The method includes a first step of performing a first wood working operation using a first power tool disposed within a first workstation and operationally engaged through a first power tool access assembly disposed on a worktable. A second step includes performing a second wood working operation using a second power tool disposed within a second workstation and operationally engaged through a second power tool access assembly disposed on the worktable. Wherein the worktable enables dual operation of the first and second power tool.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an isometric illustration of a table saw assembly including a first workstation disposed with a first saw assembly including a first motor coupled with a first saw blade and a second workstation disposed with a second saw assembly including a second motor coupled with a second saw blade, the first and second workstations coupled with a worktable disposed with a fence in accordance with an exemplary embodiment of the present invention;

FIGS. 2A and 2B are perspective views illustrating a height adjustment assembly disposed within the second workstation and coupled with the second saw assembly for raising and lowering the second saw blade relative to the plane of the worktable;

FIG. 3 is a perspective view illustrating a combination bevel and height adjustment assembly disposed within the first workstation and coupled with the first saw assembly for enabling the positioning of the first saw blade at a desired height and angle relative to the horizontal plane of the worktable;

FIG. 4 is an exemplary illustration of a handle employed within the height adjustment assembly and the combination bevel and height adjustment assembly of the present invention;

FIG. 5 illustrates a table saw assembly further comprising a router station in accordance with an exemplary embodiment of the present invention;

FIG. 6 illustrates an embodiment of a fence in an unlocked orientation;

FIG. 7 illustrates an embodiment of the fence in a locked orientation;

FIG. 8 illustrates a table saw assembly further comprising a storage compartment in accordance with an exemplary embodiment of the present invention;

FIG. 9 illustrates the storage compartment capable of being mounted between the first and second workstations of the table saw assembly;

FIGS. 10 and 11 illustrate drawers that fit within the storage compartment of FIG. 9;

FIG. 12 illustrates a table saw assembly having a single power off button for all power tools disposed within the first and second workstations;

FIG. 13 illustrates a circuit for turning off power to the power tools disposed in the table saw assembly of FIG. 12;

FIG. 14 is an illustration of a method of performing woodworking operations in accordance with an exemplary embodiment of the present invention; and

FIG. 15 is a block diagram illustrating a method of manufacturing a table saw assembly.

### DETAILED DESCRIPTION OF THE INVENTION

Reference will now be made in detail to the presently preferred embodiments of the invention, examples of which are illustrated in the accompanying drawings.

Referring generally now to FIGS. 1 through 13, the present invention provides a table saw assembly capable of enabling multiple power tool functionality within the typical footprint of a standard table saw assembly. This assists in optimizing the use of space which may be critical in a workshop or other woodworking environments. In preferred embodiments, multiple power tool functionality is enabled by a dual saw blade table saw assembly. However, it is contemplated, and will be shown and described below, that other power tools, such as a router assembly, may be employed with the system of the present invention. Referring now to FIG. 1, a table saw assembly 100 comprising a first workstation 102 and a second workstation 108 both operationally coupled with a worktable 106, is shown. The worktable 106 may be secured to the first and second workstation 102 and 108. The worktable 106 may be secured via ledges, grooves, and other retaining features under the worktable and/or at the tops of the workstations. Bolts, screws, brackets, and the like may be used in addition or in the alternative. It is contemplated that the worktable 106 may be removed from the first and second workstation 102 and 108 and that the workstations may be employed for use without the worktable 104. Alternatively, the worktable 106 may be integrally coupled with the first and second workstation 102 and 108.

Further, the worktable 106 may have an extension member, such as an extendible wing(s), to enable a larger planar work surface. The extension member may be connected to one or both ends of the worktable 106. For example, on the end of the worktable 106 proximal to the first workstation 102, an extendible wing assembly may be connected. The extendible wing assembly may include a planar extension member connected to the end of the worktable 106 via a mechanical connector. The mechanical connector, being a spring loaded joint, allows a user of the extension member to securely position the planar extension member in a first “extended” position along the same plane as the worktable 106 or retract the planar extension member into a second “closed” position. The second “closed” position may vary in that any positioning of the planar extension member, other than in a planar relationship with the worktable 106, may be the closed position. The extension member provides a user of the table saw assembly 100 with the ability to support variously sized work pieces during the performance of a cut by the table saw assembly 100. It is contemplated that various mechanical connection systems may be employed to enable the functionality of the extension member, such as a snap-lock system, latch system, compression lock system, and the like. Further various fasteners may be utilized to connect the planar extension member to the worktable 106, such as screws, bolts, clips, pins, and the like, which provide a secure mechanical connection.

Preferably, the first workstation 102 includes a first housing 103 disposed with a saw assembly comprising a motor coupled with a first saw blade 104. Accordingly, the second workstation 108 includes a second housing 109 including a saw assembly comprising a motor coupled with a second saw blade 110. The first saw blade 104 extends up through a first power tool access assembly 112 in the worktable 106. In the current embodiment, the first power tool access assembly 112 is a throat plate for allowing the first saw blade 104 to extend through the worktable 106. The first and/or second saw blade 104 and 110 may be a dado blade, a narrow kerf blade, a carbide blade, and the like, to allow a user the ability to determine and perform a wide variety of cuts. A second saw assembly, disposed within the housing 109 of the second workstation, includes a motor coupled with a second saw blade 110 extending up through a second power tool access assembly 114. It is to be understood that the first and second power tool access assembly 112 and 114 may be similarly configured and constructed or may differ from one another. For example, the first power tool access assembly 112 may be a throat plate configured with a first and second plate, which interlock while the second power tool access assembly 114 may be a throat plate configured with a single plate. Other variations of the power tool access assemblies, as contemplated by those of ordinary skill in the art, may be employed.

Preferably, the first and second workstation 102 and 108 are constructed of cast iron or metal of sufficient strength to collectively support a worktable. The sheet metal may be a framework of interconnected posts or beams or may be formed in such a manner as to be a sufficiently rigid durable structure without a framework. The posts of a framework may be solid or hollow and may have cross sections that are circular, oval, square, or rectangular. Sheets of strong, rigid, and durable material, such as metal, plastic, or wood, are attached to the framework. The sheets, with or without a framework, may be secured by screws, bolts, rivets, welded joints, and the like. Enhanced structural strengthening members may be added to the workstation. For example, reinforcing posts, beams, ribs, and the like may be mounted between the substantially vertical side surfaces and/or posts of the workstation body. The reinforcing elements may even form a reinforcing structure which extends as a three dimensional matrix through large portions of the interior of the workstation.

It is contemplated that reinforcing members, such as beams, may be used to secure the two workstations together in such a manner as to cause the two workstations to essentially move in unison. This may provide increased ease of use in a work environment where the table saw assembly 100 is required to be moved or when the table saw assembly 100 is being transported to and from a worksite.

Power to the power tools may be separately controlled for each workstation such that the power control 122 determines the operation of the saw assembly disposed within the first workstation 102 and the power control 124 determines the operation of the saw assembly disposed within the second workstation 108.

The worktable 106 is further disposed with a plurality of slots 162, 164, 166, and 168. In the current embodiment, slot 166 is disposed with a miter gauge 116. Each of the slots may be enabled with miter gauges, sliding panel holders, and the like, to provide enhanced functionality to the worktable 106. The location, number, and dimensional characteristics of the slots disposed on the worktable may vary as contemplated by one of ordinary skill in the art. It is contemplated that the worktable 106 may be configured with no slots, one slot, or a variety of slots to provide a selection of worktable 106 configurations to meet varying consumer demands.

It is contemplated that various power tools and woodworking aids may be disposed within the first and second workstation 102 and 108 and operationally engaging through the worktable 106. Additionally, the first and second workstation 102 and 108 may include various mounting assemblies in order to mount various power tools within the respective housings 103 and 109.

The worktable 106 is coupled with a fence 118. The fence 118 may be capable of adjustment by sliding the fence along the length of worktable 106. This adjusting capability allows the fence 118 to be used in relation to either the first power tool access assembly 112 or the second power tool access assembly 114. In the alternative, the fence 118 may be confined to a portion of the length of the worktable 106. For example, the fence 118 may be limited in range of movement based on distance to and from the first saw blade 110 of the first work station 102. The fence 118 includes a handle 120 which is in operational connection with a fence locking mechanism that provides the user with the ability to lock and unlock the fence 118 in a particular position through a mechanical connection with the worktable 106. For example, the handle 120 may be actuated in a rotary motion, similar to a hand crank, in which a threaded bolt with an end pad releasably contacts the worktable 106. Alternatively, the locking mechanism may be a compression lock mechanism, spring loaded lock mechanism, friction fit lock mechanism, and the like, which assist a user in easily unlocking and locking the fence 118 in multiple positions along the worktable 106.

The fence 118 may be coupled with various devices which aid in performance of woodworking tasks. For example, a digital readout display which provides a display of distance measurements accomplished by a measuring assembly may be coupled with the fence 118. The measuring assembly may include at least one laser source which emits an incident laser beam. In operation, it is contemplated that the incident laser beam is reflected from the saw blade back to the measuring assembly which processes the information to determine the distance between the saw blade and the near side of the fence. The measuring assembly may be a singular device on top of the fence 118 or may comprise two or more housings disposed with light sources, such as laser sources, light emitting diodes, and the like. The digital readout display may be disposed near the handle 120 of the fence 118, however, the digital readout display may be located in various positions either on the fence 118, the first workstation 102, the second workstation 108, or the worktable 106.

The fence 118 may further include an emergency stop assembly comprising a selector operationally coupled with the power feed to the one or more power tools being employed by the system of the present invention. In a preferred embodiment, the selector is disposed on the fence 118 near the handle 120. The selector may be a variety of configurations, such as a button, switch, and the like. In an alternative embodiment, the emergency stop assembly may be a radio frequency (RF) switch assembly which allows for remote activation. The RF-switch assembly may further include one or more handheld remote assemblies allowing multiple remotes to activate/de-activate the emergency stop assembly. The emergency stop assembly may be designed and wired to only shut off power to the power tool(s) or may include the capability of re-starting the power tool(s) after shut down. The emergency stop assembly, in the preferred embodiment, is operationally coupled with all power tools being employed with the table saw assembly, however, it is contemplated that the emergency stop assembly may be limited in its application. For example, a table saw assembly may be employing a saw and a router. The emergency stop assembly may be operationally coupled with both or with only the saw or only the router. Such a design scheme may be advantageous as it provides a user of the table saw assembly a variety of choices with regards to this particular feature. It is contemplated that the emergency stop assembly may be located in various places and should not be viewed as limited to the fence 118. For instance, the emergency stop assembly may be disposed on the first or second workstation 102 or 108 or the worktable 106.

In the preferred embodiment, the first workstation 102 is coupled with a mobile transportation assembly comprising a first base 140 and a plurality of wheels as exemplified by a first wheel 144 and a second wheel 146. The second workstation 108 is also coupled with a mobile transportation assembly comprising a second base 142 and a plurality of wheels as exemplified by a third wheel 150 and a fourth wheel 148. It is understood that the plurality of wheels may be a variety of devices, such as casters, rollers, and the like. The wheels may be lockable to limit movement of the workstations to two directions or may be lockable to completely prevent movement of the workstations. Further, the first and second base 140 and 142 may be shaped in a variety of configurations to match the design of the first and second workstation 102 and 108. Alternatively, the first and second workstation 102 and 108 may be enabled with pads coupled with the first and second base 140 and 142. The pads may provide greater stability and may include adjustment capabilities to selectively raise or lower portions of the workstations to maintain an even or otherwise desired surface for the worktable 106. Other configurations, such as employing skids, posts, and the like, may be employed without departing from the scope and spirit of the present invention.

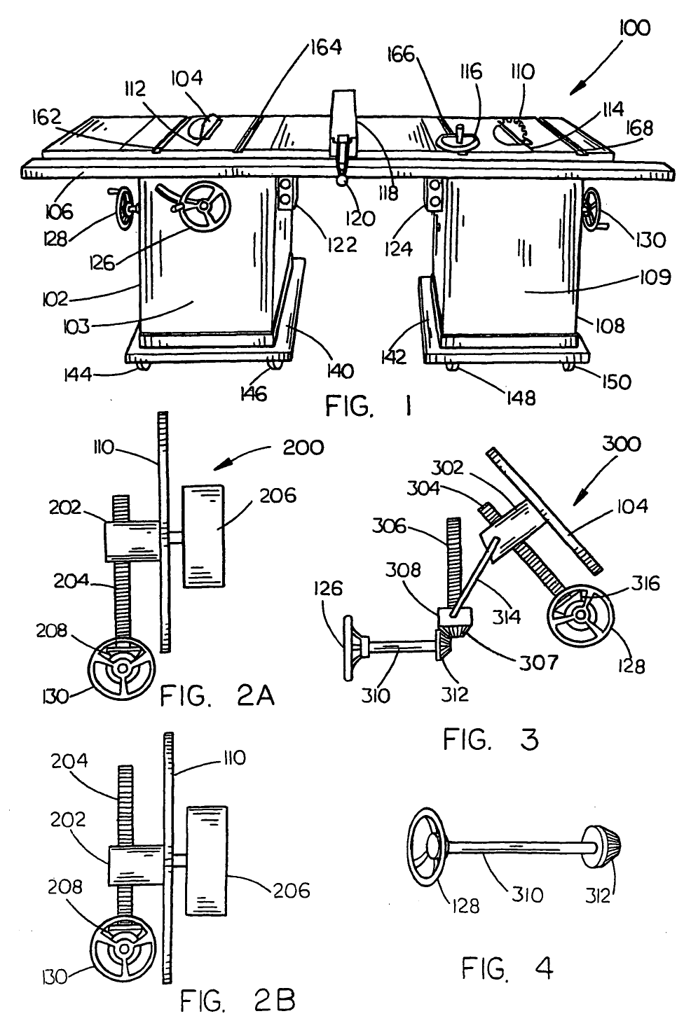

The table saw assembly includes power tool positioning mechanisms. Illustrations of the positioning mechanisms are provided in FIGS. 2 through 4. The second workstation 108 includes a height adjustment assembly 200, shown in FIGS. 2A and 2B, comprising a height adjustment wheel 130, which is seen extending from the housing 109 of the second workstation 108, shown in FIG. 1. The height adjustment wheel 130 is similar in all respects to the representative configuration of the beveling adjustment wheel 128, shown in FIG. 4. In FIGS. 2A and 2B, the first saw blade 104 is rotatably attached about a shaft included in a connector assembly 206 that is mounted to a saw blade support 202. The saw blade support 202 may be a metal block that is threaded through to permit the passage of a threaded bolt 204. The threaded bolt 204 may be coupled, on one end, with a gear 208 which couples, through engagement with a gear coupled with a shaft, with the height adjustment wheel 130. An operator may raise the saw blade, as in FIG. 2A, or lower the saw blade, as in FIG. 2B, by turning the wheel 130.

The first workstation 102 includes a combination bevel and height adjustment assembly 300, shown in FIGS. 3 and 4. The combination bevel and height adjustment assembly 300 comprises a beveling adjustment wheel 126 and a height adjustment wheel 128, which is seen extending from the housing 103 of the first workstation 102 of FIG. 1. The height adjustment wheel 128 and beveling adjustment wheel 126 have similar features. A representative illustration, FIG. 4, shows that the beveling adjustment wheel 126 couples with a shaft 310 and a gear 312 to rotate in unison. The height adjustment wheel 128 has similar couplings with a shaft and gear that is not shown, but may be understood through the example shown in FIG. 4. The beveling adjustment wheel 126, shown in FIG. 3, couples with shaft 310 and gear 312. The gear 312 engages with gear 307 coupled to threaded bolt 306. The movement of the gear 312 causes the gear 307 of a threaded bolt 306 and threaded beveling support 314 to turn. A traveling support member 308 is operationally coupled with the threaded bolt 306 and moves along the threaded bolt 306 during rotation of the beveling adjustment wheel 126. A lever 314 is pivotally attached, on one end, to the traveling support member 308 and is pivotally attached, on another end, to a saw blade support 302. As the traveling support member 308 moves along the threaded bolt 306, the lever 314 is moved so as to exert either a pulling force or a pushing force on saw blade support 202 thereby determining the angular position of the first saw blade 104 coupled to the saw blade support 302.

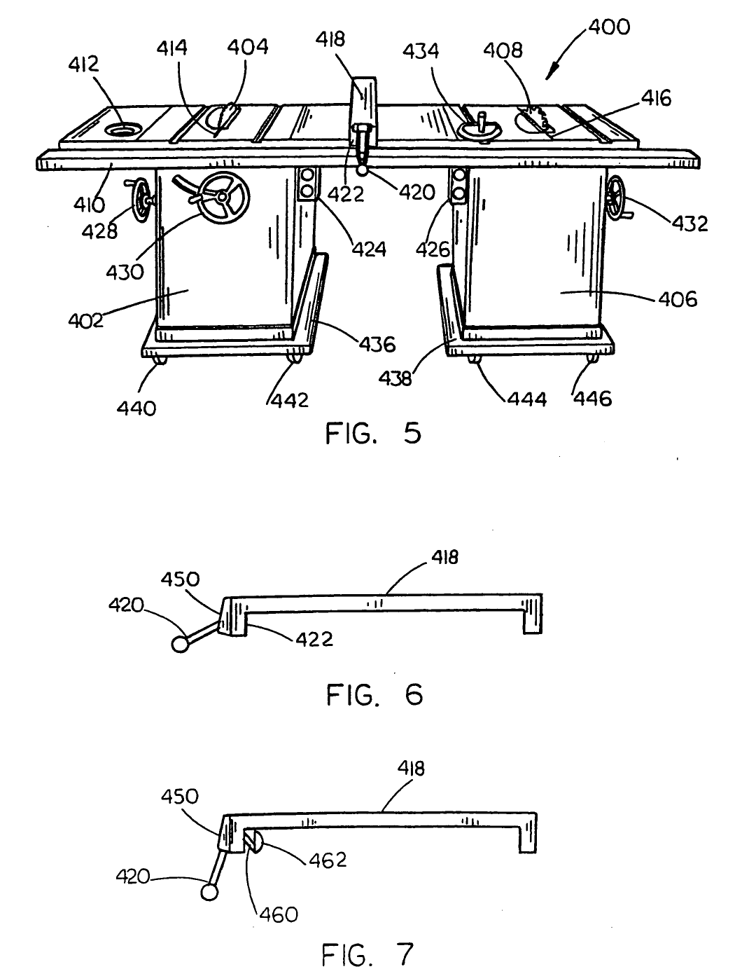

FIG. 5 illustrates an embodiment of a table saw assembly 400 similar in every respect to the table saw assembly 100, except that table saw assembly 400 includes a router station 412 built into worktable 410. Alternatively, the router may be built in an extended part of the worktable outside either of the two workstations; for example, in an extension table or extension wing. The router mounting area may have preformed holes to facilitate installation of the router. The router mounting area may be a recessed opening that provides ledges for the router's support. If no router is to be installed, a solid piece of worktable material may be secured within the recessed opening by means of screws, nails, bolts, glue, or other suitable attachment methodology.

It is further contemplated that the router station 412 may be located in the worktable 410 directly over the first or second workstation 402 or 406. In such an embodiment, the housing of the workstations may further include a router mounting assembly. A depth adjustment assembly may be operationally associated with the router station 412 in any of the above described locations for the router station 412. It is understood that the configuration of the router station 412 may be varied to accommodate a variety of router types without departing from the scope and spirit of the present invention.

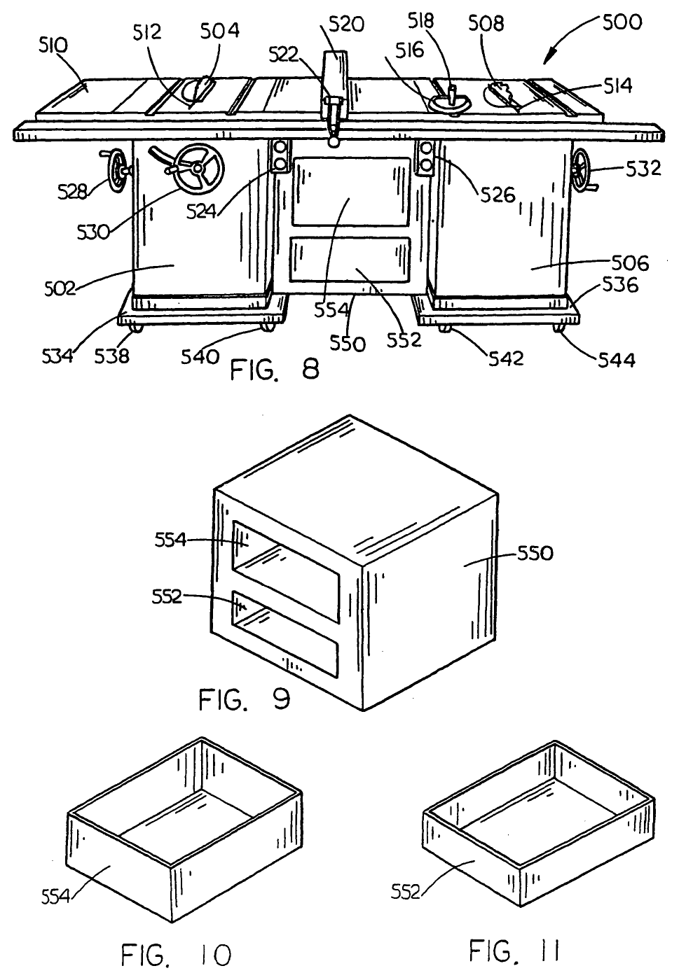

FIGS. 6 and 7 illustrate an embodiment of a fence 418 useable with the table saw assemblies of the present invention. FIG. 6 illustrates an unlocked configuration of the fence 418. A rotatable handle 420 may be extended from a housing 450 affixed to an end of the fence 418. The extension of the rotatable handle 420 causes a brake pad to withdraw within the fence end 422 which allows movement of the fence 418. FIG. 7 illustrates a locked configuration of the fence 418. The rotatable handle 420 is retracted toward the worktable causing the brake pad 462 to be extended toward the worktable. The brake pad 462 may be supported by a lever 460, as shown, or various other configurations as contemplated by one of ordinary skill in the art.

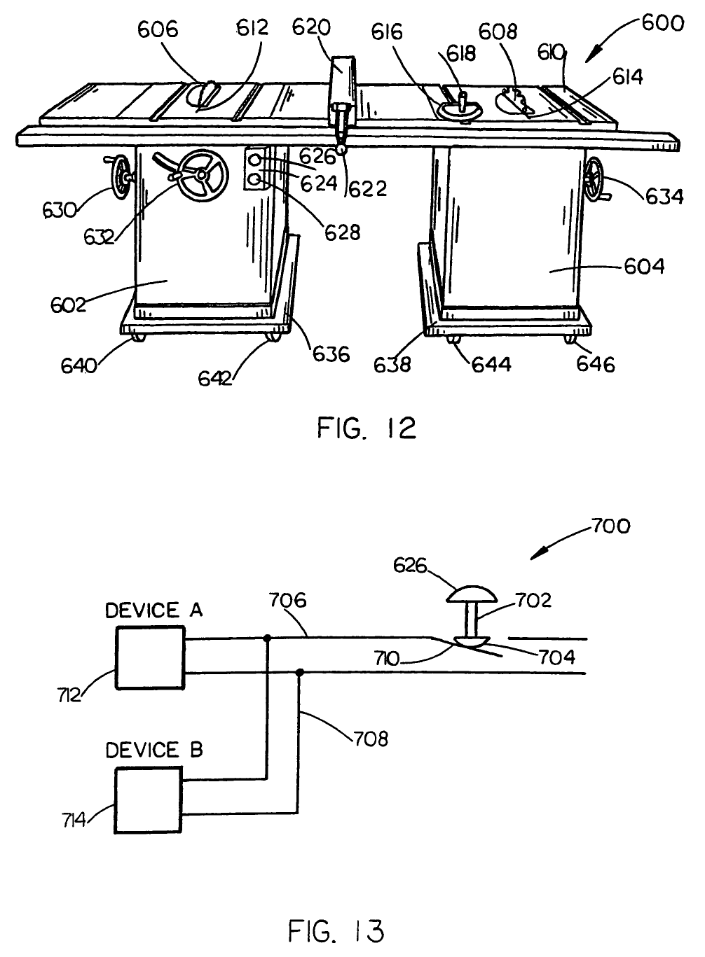

Referring generally now to FIGS. 8 through 11 a table saw assembly 500, similar in every respect to the table saw assembly 100 except that table saw assembly 500 further includes a storage compartment 550, is shown. In the preferred embodiment, the storage compartment 550 includes a first drawer 552 and a second drawer 554. The storage compartment 550 is removable from the dual workstation as the first and second drawer 552 and 554 are removable from the storage compartment 550. It is understood that the configuration of the storage compartment 550 may include shelves, doors, and the like in order to provide a customized look for a consumer. The doors may be attached by a hinge or a slide mechanism. The storage compartment 550 may be a shelf storage compartment having one or more shelves to provide storage space for items such as manuals. The shelves may be L-shaped for easy removeability. Multiple shelf sizes may be available for customizing a workstation.

The storage compartment 550 may couple with the dual workstations through a mounting assembly. The mounting assembly may include a first mounting bracket disposed on the first workstation 502 and a second mounting bracket disposed on the second workstation 506. First and second mounting members may be disposed on the storage compartment 550 and engage with the first and second mounting brackets, respectively. Other coupling assemblies may be employed as contemplated by one of ordinary skill in the art. Alternatively, the storage compartment 550 may be integrally formed into the table saw assembly 550, becoming incapable of removal.

It is contemplated that the configuration of the table saw assembly 500 may be varied in order to accommodate a variety of storage compartment sizes. For example, the first and second workstation 502 and 506 may be spaced further apart from one another or closer together depending on the desired specification provided. In this manner, the storage compartment may be sized to fit whatever specifications are desired. It is understood that the spacing of the first and second workstations and the sizing of the storage compartment do not require an adjustment of the size of the worktable 510. It is contemplated that the configuration of the worktable 510, such as the location of slots and power tool access assemblies, may be varied to accommodate any changes made.

FIGS. 12 and 13 illustrate an embodiment in which a table saw assembly 600 is similar in every respect to the table saw assembly 100 except that table saw assembly 600 includes a unitary power controller assembly comprising a housing 624 with a power on button 626 and power off button 628. Preferably, the housing 624 is coupled with the first workstation 602. Alternately, the housing 624 may be coupled with the second workstation 604 or may be remote to the table saw assembly 600. A relatively large power off button 628 may be installed to facilitate power turn off in an emergency. Electrical wiring between the two workstations may be installed through a tube that permits easy and secure attachment to and easy release from the individual workstations. If the worktable is designed for permanent attachment, an electrical wiring conduit may be disposed within the worktable.

An exemplary circuit 700 with a power cutoff switch 710 is shown in FIG. 13. Device A 712 may be disposed within the first workstation 602. Device B 714 may be disposed within the second workstation 604. A power supply line 706 may supply power to both device A 712 and device B 714. A ground wire 708 or the remainder of any alternating current lines remain connected to device A 712 and device B 714. An operator may depress the power off button 628 to disconnect power to devices A and B. The material of the end knob 704 of the power off button 628 is preferably of an insulating material, such as plastic. The switch that actually interrupts the supply of power may be physically separated from the manual operated power off switch.

Other variations of the present invention may be practiced. For instance, a ruler scale may be included in any of the above described embodiments. The ruler scale may provide an indicator for the user of the table saw assembly, identifying the beveled angle of the saw blade or a height of the saw blade. Further, a removable dust bin may be connected with either or both workstations. The workstation(s) described in FIGS. 1 through 13 may be disposed with a dust collection system. In such an instance, the worktable of the present invention may comprise a dust collection worktable with through points or mat members that allow for dust collection which may be coupled with and removable from the worktable. The dust collection worktable is further connected with a blower via a collection tube. The collection tube may allow the blower to transport the dust, debris, and other loose material, from the worktable, into a dust bin or dust bag. It is further contemplated that the number and type of dust bins or bags connected with the blower via the collection tube may vary as contemplated by those of ordinary skill in the relevant art, in order to increase or decrease the volume of dust collection available.

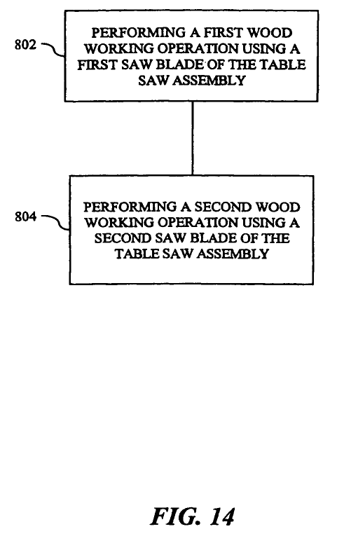

A method for performing woodworking operations using the table saw assembly 100, is shown in FIG. 14. In a first step 802, a user of the table saw assembly 100 performs a first wood working operation using the first saw blade disposed within the first workstation and operationally engaged through the first power tool access assembly disposed on the worktable. The first saw blade may be vertically adjusted to vary the depth of cut performed by the blade. Additionally, the first saw blade may be beveled so that it may perform an angled cut, the angle of presentation being relative to the horizontal plane of the worktable. For example, in the first step 802 an angled cut of forty five degrees may be performed upon a work piece. In a second step 804, the user of the table saw assembly 100 performs a second wood working operation using a second saw blade disposed within the second workstation and operationally engaged through the second power tool access assembly disposed on the worktable. In the current example, after the angled cut is performed, the user may transfer the work piece directly to the second saw blade and perform a straight cut.

In the exemplary method discussed above, the table saw assembly 100 provides improved performance of a woodworking operation upon a work piece. Time may be saved by requiring the user to only make a single adjustment to perform an angled cut. Further, time may be saved by establishing saw blades with desired kerf characteristics in each workstation thereby eliminating the need to replace blades between each cut. Precision and accuracy in the cut may be enhanced due to the ability to maintain the blades in their respective positions and not requiring a re-alignment of blade position between each cut. Additionally, wear on a saw blade may be reduced by not requiring a single blade to perform multiple cut tasks in multiple positions.

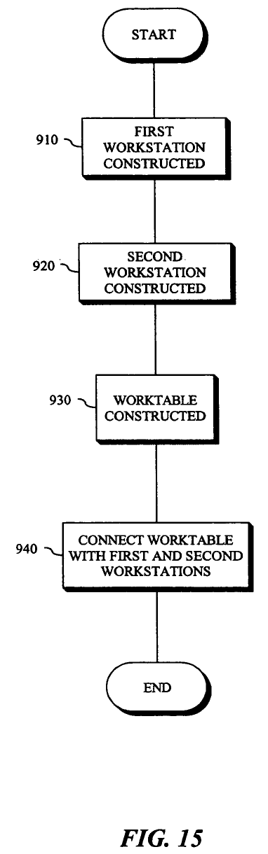

A method for manufacturing a table saw assembly 100 is shown in FIG. 15. In a first step 910, a first workstation is constructed. In a second step 920, a second workstation is constructed. It is to be understood that the first and second workstations may be similar to the first and second workstation 102 and 108. Further, the various alternative embodiments described above in relation to the first and second workstation 102 and 108 may be included in the construction. After the first and second workstations are constructed, a worktable including a first and second power tool access assembly is constructed in step 930. The worktable of the present method being similar in all respects to the worktable 106 previously described. In step 940 the worktable is connected With the first and second workstations. The connection allows for the operation of any power tool established within the first and second workstations.

In an additional step of the present invention, the worktable is constructed to include an additional power tool access assembly. For example, the worktable may include a router station which enables the connection and use of a router with the worktable, such as that previously described in reference to FIG. 5. Still further, the method of manufacture may include the steps of constructing a mobile transportation assembly, described previously and shown in FIGS. 1, 5, 8, and 12, and connecting it with the first and/or second workstations. It is also contemplated that a dust collection system may be constructed and connected with the table saw assembly 100 during the manufacturing process.

It is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. Further, the methods allow for the addition of any of the features and components previously described throughout the instant application. The accompanying method claims present elements of the various steps in a sample order, and are not necessarily meant to be limited to the specific order or hierarchy presented.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages, the form hereinbefore described being merely an explanatory embodiment thereof. It is the intention of the following claims to encompass and include such changes.

What is claimed is:

1. A table saw assembly, comprising:
a first workstation disposed with a first power tool;
a second workstation disposed with a second power tool; and
a worktable coupled with the first and second workstations, the worktable having a first power tool access assembly disposed in relation to the first power tool and a second power tool access assembly disposed in relation to the second power tool,
wherein the worktable provides for dual operation of the first and second power tool.

2. The table saw assembly of claim 1, wherein the first power tool is a saw.

3. The table saw assembly of claim 1, wherein the second power tool is a saw.

4. The table saw assembly of claim 1, wherein the worktable is further disposed with a router station.

5. The table saw assembly of claim 1, wherein the worktable is disposed with a fence assembly.

6. The table saw assembly of claim 1, further comprising a storage compartment.

7. The table saw assembly of claim 1, further comprising an emergency stop which cuts the power to the first and second power tools.

8. The table saw assembly of claim 1, wherein the worktable is removable from the first and second workstations.

9. The table saw assembly of claim 1, further comprising an extension member connected to the worktable.

10. A table saw assembly, comprising:
a worktable including a first blade access assembly and a second blade access assembly;
a first workstation coupled with the worktable, the first workstation comprising a saw assembly including a motor coupled with a first saw blade, the first saw blade operationally engaging through the first blade access assembly of the worktable; and
a second workstation coupled with the worktable, the second saw assembly comprising a saw assembly including a motor coupled with a second saw blade, the second saw blade operationally engaging through the second blade access assembly of the worktable,
wherein the worktable provides for dual operation of the first and second saw assembly.

11. The table saw assembly of claim 10, wherein the first workstation further comprises a combination bevel and height adjustment assembly.

12. The table saw assembly of claim 10, wherein the second workstation further comprises a height adjustment assembly.

13. The table saw assembly of claim 10, wherein the worktable is further disposed with a router station.

14. The table saw assembly of claim 10, wherein the worktable is disposed with a fence assembly.

15. The table saw assembly of claim 10, further comprising a storage compartment.

16. The table saw assembly of claim 10, further comprising an emergency stop which cuts the power to the first and second power tools.

17. The table saw assembly of claim 10, wherein the worktable is removable from the first and second workstations.

18. The table saw assembly of claim 10, further comprising an extension member connected to the worktable.

19. A method for performing woodworking operations, comprising the steps of:
performing a first wood working operation using a first power tool disposed within a first workstation and operationally engaged through a first power tool access assembly disposed on a worktable; and
performing a second wood working operation using a second power tool disposed within a second workstation and operationally engaged through a second power tool access assembly disposed on the worktable, wherein the worktable enables dual operation of the first and second power tool.

20. The method of claim 19, further comprising performing the first wood working operation after performing the second wood working operation.

21. The method of claim 19, wherein the first wood working operation involves cutting by a table saw.

22. The method of claim 19, wherein the second wood working operation involves a dado blade.

23. The method of claim 19, wherein the first and second power tools remain mounted and unchanged.

24. The method of claim 19, further comprising a third operation using a router connected with the worktable by a router station disposed in the worktable.

25. The method of claim 19, wherein at least one of the first, second, and third operations is performed using a fence moveably mounted upon the worktable.

26. A table saw assembly, comprising:
means for performing a first cut upon a work piece; and
means for performing a second cut upon the work piece.

27. The table saw assembly of claim 26, wherein the means for performing a first cut comprises a worktable, including a first blade access assembly, coupled with a first workstation including a motor coupled with a first saw blade, wherein the first saw blade operationally engages through the first blade access assembly to perform a first cut upon the work piece.

28. The table saw assembly of claim 26, wherein the means for performing a second cut comprises the worktable, including a second blade access assembly, coupled with a second workstation including a motor coupled with a second saw blade, wherein the second saw blade operationally engages through the second blade access assembly to perform a second cut upon the work piece.
